(19) United States
(12) Patent Application Publication
(10) Pub. No.: US 2019/0117495 A1
(43) Pub. Date: Apr. 25, 2019

(54) AIR ABSORBING AND DISCHARGING MASSAGER

(71) Applicant: Guozhu ZHANG, Xi'an City (CN)

(72) Inventor: Guozhu ZHANG, Xi'an City (CN)

(21) Appl. No.: 15/791,433

(22) Filed: Oct. 24, 2017

(51) Int. Cl. A61H 9/00

(52) U.S. Cl. CPC A61H 9/0071; A61H 2201/1238; A61H 2201/5025

(57) ABSTRACT

An air absorbing and discharging massager, comprising: a housing, an air pump, a solenoid valve, a PCB board and a silicone massaging case connected to the air pump through a nozzle rack; the air pump connected to the solenoid valve. The air pump and the solenoid valve controls the silicone massaging case to absorb or release air so as to obtain a squeezing and inflating massage effect; the nozzle rack includes a filter screen. A user is covered by the massage cavity and uses an air pump and a solenoid valve to realize an air absorbing and releasing action, so that the massage cavity can be squeezed or inflated, and the user can receive a comfortable massaging and stimulating feeling.

### BACKGROUND OF INVENTION

### 1. Field of the Invention

The present invention relates to an air absorbing and discharging massager.

### 2. Description of Related Art

A massager is a healthcare appliance developed on the basis of physics, bionics, bioelectricity, Chinese medicine and years of clinical practice. As a new healthcare product, it can help enhancing local blood circulation and accelerating metabolism of the human body, so as to release fatigue and keep fit. Nowadays, there are more and more massager products featuring small sizes, home use, high-tech or even intelligence. Some low-tech products are more inclined to home use, and are incorporated into electric home appliances. High-tech products are increasingly involved with microelectronics, digital technology, biomedical engineering and new-function materials technology.

### SUMMARY OF THE INVENTION

It is an object of the present invention to overcome the drawbacks of the prior art and to provide an air absorbing and discharging massager, which comprises an housing, an air pump disposed inside the housing, a solenoid valve, a PCB board, and a silicone massaging case disposed outside the housing;

the housing including a nozzle rack having a connecting pipe;

the air pump including a first nozzle and a second nozzle, wherein the first nozzle is connected to the connecting pipe of the nozzle rack, and the second nozzle is connected to the solenoid valve;

the silicone massaging case disposed on the connecting pipe of the nozzle rack, and having a cavity connected to the first nozzle of the air pump through the connecting pipe;

when the solenoid valve is closed, the air flow generated by the air pump is discharged through the first nozzle, and charges the cavity of the silicone massaging case through the connecting pipe;

when the solenoid valve is open, the air inside the cavity comes out through second nozzle, and is discharged through the solenoid valve; by filling or discharging the cavity, the silicone massaging case is squeezed or inflated, and a massage effect is obtained.

More preferably, wherein the connecting pipe includes a filter screen.

More preferably, wherein the connecting pipe includes a mounting hole, and the filter screen is inserted into the mounting hole.

More preferably, wherein one end of the nozzle rack facing the air pump is formed with an air intake hole connected to the connecting pipe; the first nozzle of the air pump is connected to the air intake hole through the second silicone air pipe; while the second nozzle of the air pump is connected to the air intake hole of the solenoid valve through the first silicone air pipe.

More preferably, wherein the nozzle rack includes an air discharging hole.

More preferably, wherein the housing includes an opening, and the nozzle rack is disposed on the opening; the nozzle rack includes a hook disposed in one side thereof for engaging with the opening.

More preferably, wherein the housing includes an upper housing and a lower housing buckled together with the upper housing; the air pump, solenoid valve, PCB board are disposed inside a space formed by the upper and lower housing.

More preferably, wherein the PCB board includes a button exposed a through hole on the upper housing.

More preferably, wherein the housing has a battery installed therein.

More preferably, wherein the housing is covered by a silicone case.

When using the present invention, attach the silicone massaging case to the part of human body needing massage, use the human body to seal the cavity of the silicone massaging case, and operate the air pump and solenoid valve to absorb or discharge air to squeeze/inflate the cavity of the silicone massaging case. The user will receive a comfortable feeling of massage and stimulation. The present invention features easy and convenient operation and can meet the demand of consumers.

Comparing with prior art, it has the following advantages: simple structure, small size, no need for a mechanical transmission structure, and using the change of air pressure inside the massage case to obtain a squeezing massage effect.

### BRIEF DESCRIPTION OF THE DRAWINGS

FIG. 1 is a perspective view of the present invention;

FIG. 2 is a top view of the present invention;

FIG. 3 is an A-A sectional view of FIG. 2;

FIG. 4 is a perspective exploded view of the present invention;

FIG. 5 is an exploded view of the assembly between the housing, the silicone massaging case, the nozzle rack, and the filter screen of the present invention;

FIG. 6 is an exploded view of the assembly between the nozzle rack and the components inside the housing.

### DETAILED DESCRIPTION OF THE INVENTION

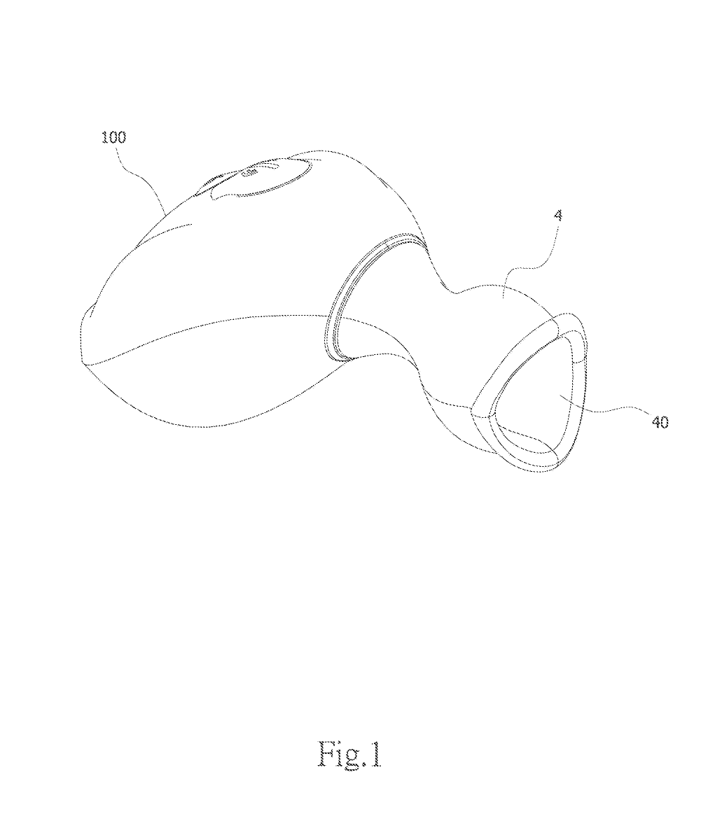

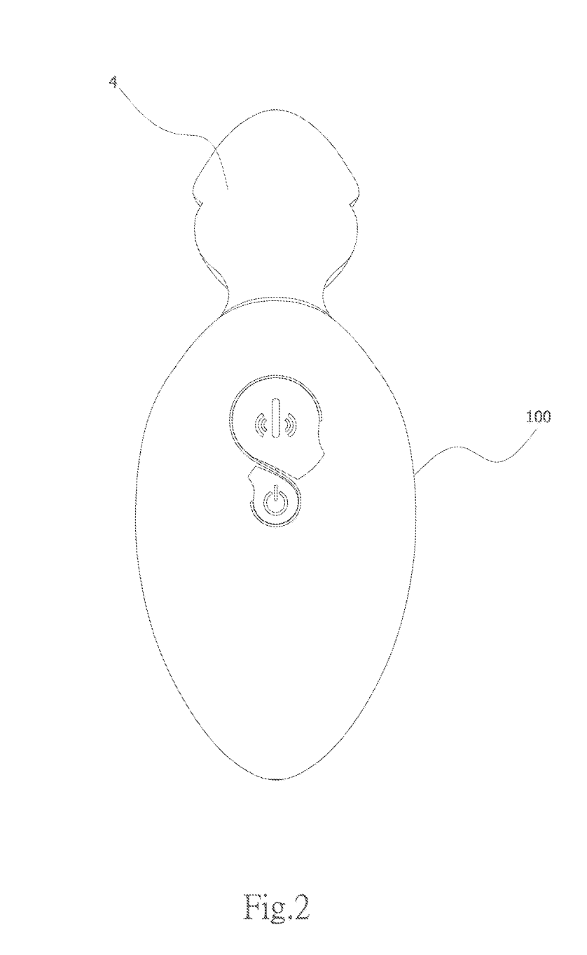

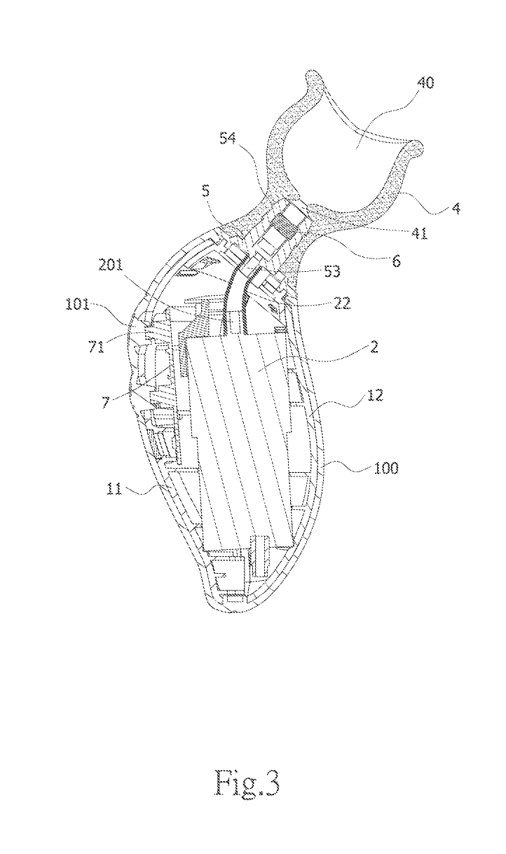

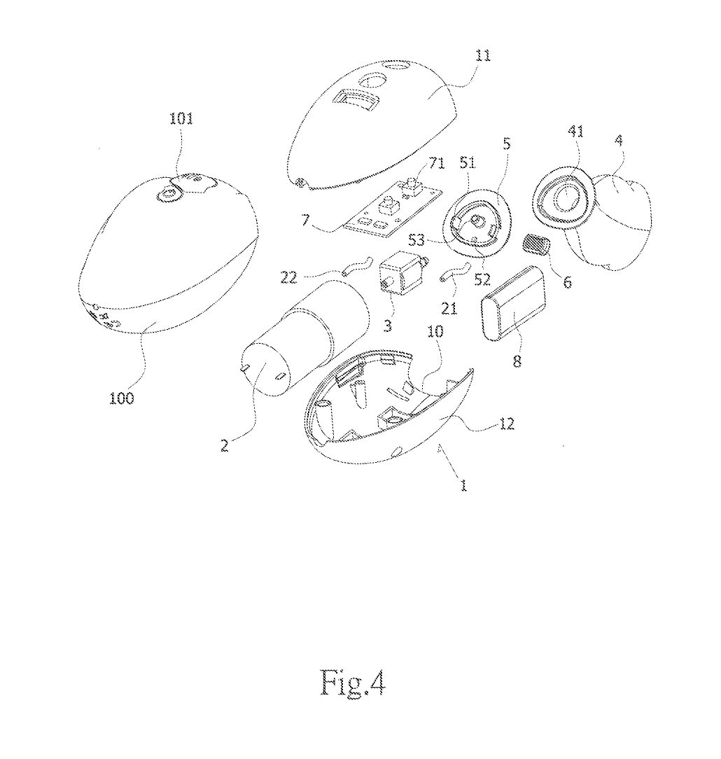

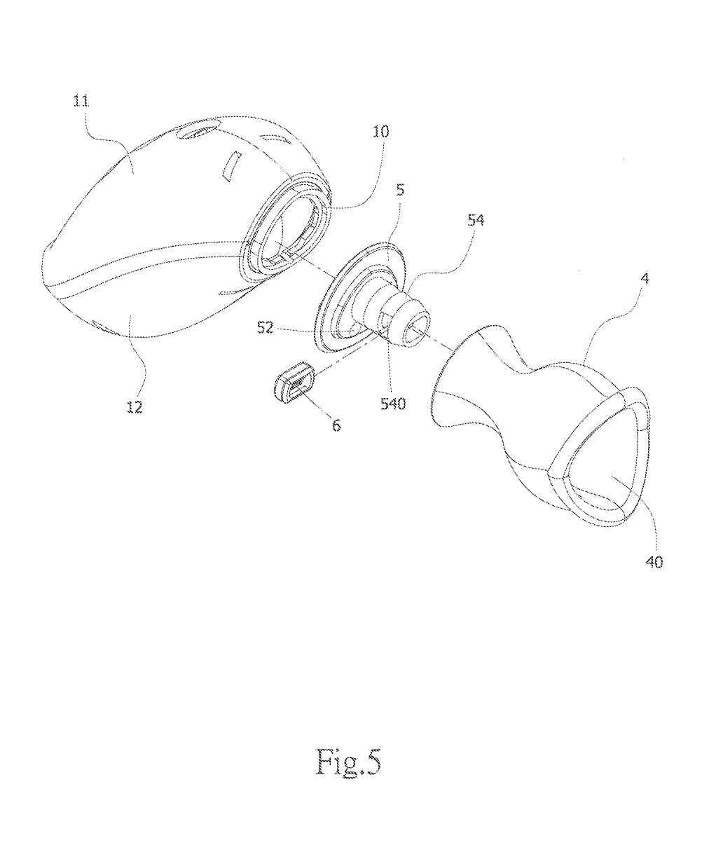

FIGS. 1-6 depict an air absorbing and discharging massager, which comprises: an housing 1, an air pump 2 installed inside the housing 1, a solenoid valve 3, a PCB board 7, a battery 8, and a silicone massaging case 4 installed outside the housing 1 and connected to the air pump 2. The silicone massaging case 4 is connected to the air pump 2 through a nozzle rack 5 installed on the housing 1. Through the air pump 2 and solenoid valve 3, the silicone massaging case 4 absorbs or discharges air, and the silicone massaging case 4 generates a squeezing/inflating massage effect.

The housing 1 comprises: an upper housing 11 and a lower housing 12 that can be buckled together to form a shape similar to an egg. The air pump 2, solenoid valve 3, PCB board 7, and battery 8 are all installed inside the cavity formed by the housing 1. To enhance the comfort of holding the product, the housing 1 is covered with a silicone case 100. The air pump 2 and solenoid valve 3 are both connected to the PCB board 7, and a battery 8 is used as power supply. The PCB board 7 is configured with a control button 71. The button 71 is exposed outside the through-hole on the housing 11. Finally, the button is covered by the external silicone case 100. At the position corresponding to the button 71, the silicone case 100 is formed with a buckling position 101. When using, the user just needs to push place corresponding to the a buckling position 101 on the silicone case 100. To facilitate operation, the place corresponding to the buckling position 101 on the surface of the silicone case 100 is painted with a corresponding mark.

The housing 1 is configured with an opening 10, and the opening 10 is configured with a nozzle rack 5. The nozzle rack 5 has a body shape corresponding to the shape of the opening 10, so as to seal the opening 10. The side of the nozzle rack 5 to fit the opening 10 is configured with a hook 51, so that the nozzle rack 5 can be hooked at the opening 10, and the nozzle rack 5 and housing 1 are connected and fixed.

The other side relative to the hook 51 side of the nozzle rack 5 is integrally formed with a connecting pipe 54. The connecting pipe 54 is used to connect with the silicone massaging case 4. The connecting pipe 54 is configured with a filter screen 6. The two are installed in the following manner: the connecting pipe 54 is configured with a mounting hole 540, and the filter screen 6 is inserted into the mounting hole 540. On the side of the nozzle rack 5 with configuration of the hook 51, an air intake hole 53 is formed. The air intake hole 53 is connected to the connecting pipe 54. Furthermore, the nozzle rack 5 is configured with an air discharging hole 52.

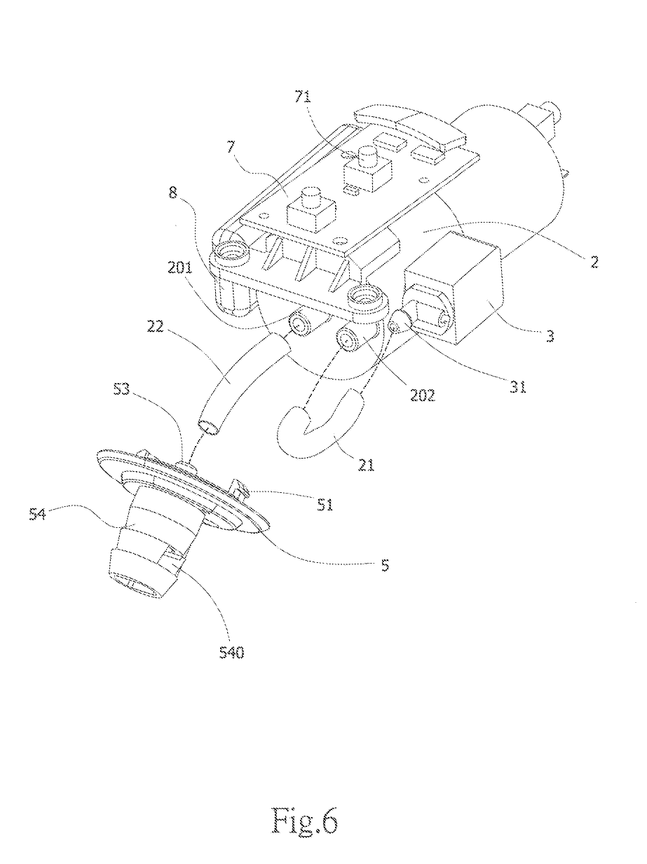

Referring to FIG. 6, the air pump 2 is configured with a first nozzle 201 and a second nozzle 202 that are connected to each other. When the air pump 2 is started, the compressed air it generates will be discharged from the first nozzle 201 and the second nozzle 202. In particular, the first nozzle 201 is connected to the air intake hole 53 through the second silicone air pipe 22; while the second nozzle 202 is connected to the air intake hole 31 of the solenoid valve 3 through the first silicone air pipe 21.

The front end of the silicone massaging case 4 has a cavity 40, and its rear end is formed with an air hole 41 connected to the cavity 40. The air hole 41 of the silicone massaging case 4 is sheathed on the connecting pipe 54 of the nozzle rack 5. To maintain constant stability, the connecting pipe 54 is formed with anti-slip ridges.

The operation of the present invention is as follows:

Firstly, attach the opening on the front end of the silicone massaging case 4 to the part of human body needing massage, such as fingers, toes, male sex organs etc. Use the part of human body needing massage to seal the cavity 40 of the silicone massaging case to form a sealed space.

Then, push the button 71 to turn on the air pump 2. During operation, when the solenoid valve 3 is closed, the air flow generated by the air pump 2 can not be discharged by solenoid valve 3 through the second nozzle 202. Hence, the air flow can only be discharged through the first nozzle 201 and then goes into the connecting pipe 54 of the nozzle rack 5 through the air intake hole 53. After passing the filter screen 6, the air flow goes into the cavity 40 of the silicone massaging case 4. The continuous air intake increases the air pressure inside the cavity 40, and the cavity 40 of the silicone massaging case 4 is inflated;

Then, the solenoid valve 3 is started, and the passage inside is connected. Now, the air flow generated by the air pump 2 can be directly discharged by the second nozzle 202 through the solenoid valve 3. Meanwhile, the high-pressure air inside the cavity 40 passes the filter screen 6, and goes back into the first nozzle 201 through the connecting pipe 54 and the second silicone air pipe 22, and be discharged by the solenoid valve 3 through the second nozzle 202. The continuous discharge of the high-pressure air inside the cavity 40 lowers the pressure inside the cavity 40, and the silicone massaging case 4 shrinks.

Along with continuous recycling of the above actions, the cavity 40 is repeatedly filled and discharged, and the silicone massaging case 4 is repeatedly squeezed and inflated. In this way, it generates a massage effect for the human body.

In the present invention, the squeezing massage effect is realized through change of air pressure inside the cavity 20 of the massaging case. The massage action is not generated directly by mechanical motions. Therefore, the massage is relatively more comfortable. The user can receive a comfortable feeling of massage and stimulation.

In the present invention, the filter screen 6 can filter the air and prevent foreign objects from entering and blocking the air passage.

In the present invention, the air discharging hole 52 on the nozzle rack 5 has the following function: when the air pump 2 is charging the cavity 40 of the silicone massaging case 4, if the pressure inside the cavity 40 is too high, due to the elasticity of the silicone massaging case 4, the high-pressure air flow inside the cavity 40 will be squeezed out from the position between the silicone massaging case 4 and the connecting pipe 54, and be discharged through the air discharging hole 52. Thus, over-charging of the cavity 40 can be avoided.

The above only describes some exemplary embodiments of the present invention. Those having ordinary skills in the art may also make many modifications and improvements without departing from the conception of the invention, which shall all fall within the protection scope of the invention.

I claim:

1. An air absorbing and discharging massager, comprising:
an housing, an air pump disposed inside the housing, a solenoid valve, a PCB board, and a silicone massaging case disposed outside the housing;
the housing including a nozzle rack having a connecting pipe;
the air pump including a first nozzle and a second nozzle, wherein the first nozzle is connected to the connecting pipe of the nozzle rack, and the second nozzle is connected to the solenoid valve;
the silicone massaging case disposed on the connecting pipe of the nozzle rack, and having a cavity connected to the first nozzle of the air pump through the connecting pipe;
when the solenoid valve is closed, the air flow generated by the air pump is discharged through the first nozzle, and charges the cavity of the silicone massaging case through the connecting pipe;
when the solenoid valve is open, the air inside the cavity comes out through second nozzle, and is discharged through the solenoid valve;
by filling or discharging the cavity, the silicone massaging case is squeezed or inflated, and a massage effect is obtained.

2. The air absorbing and discharging massager according to claim 1, wherein the connecting pipe includes a filter screen.

3. The air absorbing and discharging massager according to claim 2, wherein the connecting pipe includes a mounting hole, and the filter screen is inserted into the mounting hole.

4. The air absorbing and discharging massager according to claim 1, wherein one end of the nozzle rack facing the air pump is formed with an air intake hole connected to the connecting pipe; the first nozzle of the air pump is connected to the air intake hole through the second silicone air pipe; while the second nozzle of the air pump is connected to the air intake hole of the solenoid valve through the first silicone air pipe.

5. The air absorbing and discharging massager according to claim 1, wherein the nozzle rack includes an air discharging hole.

6. The air absorbing and discharging massager according to claim 1, wherein the housing includes an opening, and the nozzle rack is disposed on the opening; the nozzle rack includes a hook disposed in one side thereof for engaging with the opening.

7. The air absorbing and discharging massager according to claim 6, wherein the housing includes an upper housing and a lower housing buckled together with the upper housing; the air pump, solenoid valve, PCB board are disposed inside a space formed by the upper and lower housing.

8. The air absorbing and discharging massager according to claim 7, wherein the PCB board includes a button exposed a through hole on the upper housing.

9. The air absorbing and discharging massager according to claim 7, wherein the housing has a battery installed therein.

10. The air absorbing and discharging massager according to claim 1, wherein the housing is covered by a silicone case.
